(19) United States
(12) Patent Application Publication
(10) Pub. No.: US 2009/0248501 A1
(43) Pub. Date: Oct. 1, 2009

(54) Calculation method of sales allowance and computer readable recording medium thereof

(76) Inventors: Keun-Soo Yun, Seoul (KR); Kab-Su Yun, Seoul (KR)

Correspondence Address: HAMRE, SCHUMANN, MUELLER & LARSON, P.C., P.O. BOX 2902, MINNEAPOLIS, MN, 55402-0902, US

(21) Appl. No.: 11/989,647

(22) PCT Filed: Aug. 9, 2006
(86) PCT No.: PCT/KR2006/003126

§ 371 Date: Jan. 29, 2008

(30) Foreign Application Priority Data
Aug. 9, 2005 (KR) 10-2005-0072906
Mar. 16, 2006 (KR) 10-2006-0024431

(51) Int. Cl. G06Q 30/00; G06Q 10/00

(52) U.S. Cl. 705/14; 705/400

(57) ABSTRACT

Disclosed are calculation method of sales allowance and computer readable recording medium thereof that are capable of calculating allowance to be paid to respective members corresponding to each node online in a commodity or service sales method. The method comprises the steps of computing a rate of a ranking of a predetermined subscriber to the number of subscribers included on one line; computing a rate of sales of the predetermined subscriber to the total of sales of respective subscribers included on the one line; computing the rate computed in the step times the rate computed in the step times a sales allowance payment rate of new sales; automatically computing an allowance of the predetermined subscriber by the product of the value computed in the step and a predetermined invariable; and displaying the value computed in the step on the monitor of a computer. Thus, according to the present, it is possible to compute a sales allowance paid to subscribers according to respective steps simply and correctively without manager's complicated computation in case of the generation of new sales by online automatically computing allowances correctively allotted to members included on one line according to a payment rate in a commodity or service sales method.

### TECHNICAL FIELD

The present invention relates to a sales allowance payment method, more particularly to a calculation method of sales allowance and computer readable recording medium thereof that are capable of calculating allowance to be paid to respective members corresponding to each node online in a commodity or service sales method.

### BACKGROUND ART

Generally, distribution and sales of products are performed by the method that a manufacture supplies the products through a wholesaler or retailer, and then a consumer purchases the same through a wholesaler or retailer. In addition, if a consumer requests a product through a shopping mall managed online (internet connection) according to a rapid recent development of internet, a shopping mall operator ships a corresponding product to the consumer using a product distribution means (home delivery, a various type of mail). However, through this type of distribution and sales of products, consumers meet only classical economic need that a consumer is nothing but a demander.

And company has to pay acquisition cost for physical circumstances (cites, etc) and advertisement cost in order to acquire distribution network. These costs play a role in increasing cost of product through cost of production and cause devaluation of product quality. As one method for developing sales form, multi-level marketing plan has come along. And the plan is the method that a consumer satisfies his/her need (consumption) by being in a provider's shoes and simultaneously effect of killing two birds with one stone in an economical profit is capable of being fulfilled. Also the plan, on the part of company, is an accomplished sales style because distribution network is acquired through low cost.

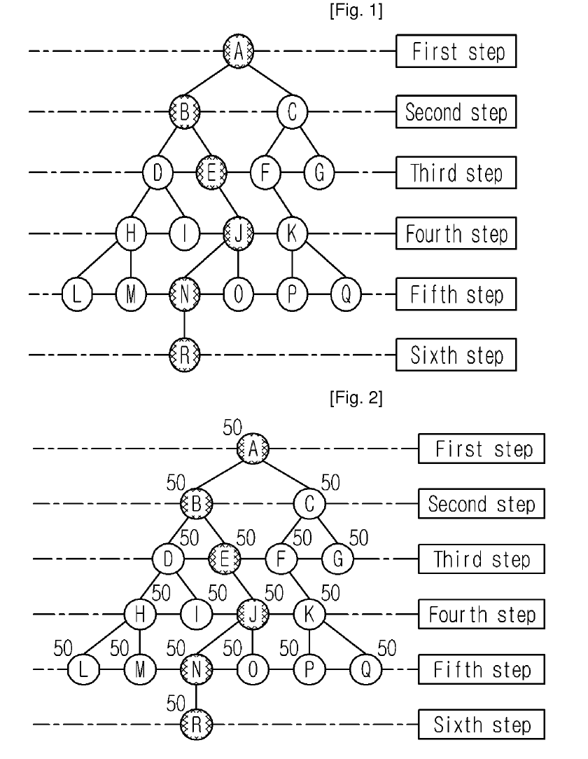

Hereinafter, a detailed explanation will be fulfilled based on FIG. 1.

FIG. 1 is a simplified plan for illustrating a sales allowance payment method in accordance with the conventional art. According to increase of a subordinated subscriber, one example of the method that a sales allowance of the subordinated subscriber is paid to an unsubordinated subscriber will be explained hereinafter.

In the case that a subordinated subscriber increases continuously, a manner of doing business of a multi-level marketing plan is that a sales allowance according to the subordinated subscriber is paid to an unsubordinated subscriber. However, though there are corresponding subscribers in various subordinated nodes, a sales allowance corresponding to new sales according to the subordinated subscribers is paid to a subscriber of only one line (shown as thick line in FIG. 1, that is, an N, J, E, B, and A subscriber belonging to a specific line). But if the new sales are 100 and a sales allowance corresponding to the new sales is 30, the sales allowance (30) is identically allotted to an N, J, E, B, and A subscriber. That is, an allotted sales allowance (6) is equally paid to the respective subscribers.

As described above, because more unsubordinated subscriber is allotted even more sales allowance than another subscriber without a specific effort, the sales allowance is monopolized to only the unsubordinated subscriber and thus sales will of a subordinated subscriber is fallen.

### DISCLOSURE OF INVENTION

### Technical Problem

Accordingly, it is an object of the present invention to provide a calculation method of sales allowance and computer readable recording medium thereof that are capable of automatically calculating allowance to be allotted to respective members corresponding to each node online in a commodity or service sales method.

In addition, it is another object of the present invention to provide a calculation method of sales allowance and computer readable recording medium thereof that are capable of computing a sales allowance based on sales of respective subscribers and a relative ranking of the subscribers in case of paying the sales allowance to subscribers included on one line.

### Technical Solution

According to obtain the object, it is a first aspect of the present invention to provide

A calculation method of sales allowance online comprising the step of: (A) computing the sales allowance based on sales of respective subscribers and a relative ranking of the subscribers in case of paying the sales allowance to subscribers included on one line.

Preferably, the method according to claim 1 further comprises (A1) computing a rate of a ranking of a predetermined subscriber to the number of subscribers included on one line; (A2) computing a rate of sales of the predetermined subscriber to the total of sales of respective subscribers included on the one line; (A3) computing the rate computed in the step (A1) times the rate computed in the step (A2) times a sales allowance payment rate of new sales; (A4) automatically computing an allowance of the predetermined subscriber by the product of the value computed in the step (A3) and a predetermined invariable; and (A5) displaying the value computed in the step (A4) on the monitor of a computer.

More preferably, the method according to claim 2 further comprises (A6) dividing the sales allowance payment rate of the new sales at a predetermined rate, and thus computing a first payment distribution rate X and a second payment distribution rate Y of the new sales; (A7) outputting a value of the value computed in the step (A4) times the first payment distribution rate X of the new sales; (A8) re-computing the rate computed in the step (A1) as an allowance corresponding to ‘1’ and then computing each subscriber allowance through the step (A1) to the step (A4); (A9) outputting a value of the value computed in the step (A8) times the second payment distribution rate X of the new sales; and (A10) summing the value computed in the step (A7) and the value computed in the step (A9), and then returning the summation value to the step (A5) through the feedback procedure.

It is a second aspect of the present invention to provide a computer readable recording medium for calculating a sales allowance online, comprising: a first computing means for computing a rate of a ranking of a predetermined subscriber to the number of subscribers included on one line; a second computing means for computing a rate of sales of the predetermined subscriber to the total of sales of respective subscribers included on the one line; a third computing means for computing the rate computed by the first computing means times the rate computed by the second computing means times a sales allowance payment rate of new sales; and a fourth computing means for automatically computing an allowance of the predetermined subscriber by the product of the value computed by the third computing means and a predetermined invariable.

### ADVANTAGEOUS EFFECTS

As disclosed above, according to the present, it is possible to compute a sales allowance paid to subscribers according to respective steps simply and correctively without manager's complicated computation in case of the generation of new sales by online automatically computing allowances correctively allotted to members included on one line according to a payment rate in a commodity or service sales method.

According to the present, it is possible to compute a sales allowance based on sales of respective subscribers and a relative ranking of the subscribers in case of paying the sales allowance to subscribers included on one line, thereby highly to enhance sales intent of subordinated subscribers.

### BEST MODE FOR CARRYING OUT THE INVENTION

Hereinafter, preferable embodiments according to the present invention will be described with reference to the accompanying drawings. Here, when one element is connected to another element, one element may be not only directly connected to another element but also indirectly connected to another element via another element.

Further, irrelative elements are omitted for clarity. Also, like reference numerals refer to like elements throughout.

Referring to FIGS. 2 through 6, a preferable embodiment that easily embodied by a person having ordinary skill in the same art that belongs to the present invention will be described in more detail. FIG. 2 is a simplified plan for illustrating a sales allowance payment method in accordance with one embodiment of the present invention.

As depicted in FIG. 2, illustrated is one example that an allowance corresponding to a certain rate of sales generated by a subordinated subscriber according to increase of a subordinated subscriber is paid having regard to sales between unsubordinated subscribers having same sales and a ranking rate of corresponding lines.

Herein, method for computing the allowance online is as the following equation 1.

Subscriber allowance=invariable×(subscriber step)/(generation step of new sales)×(own sales)/(the total of sales of subscriber paid sales allowance)×(dividend rate of new sales) [Equation 1]

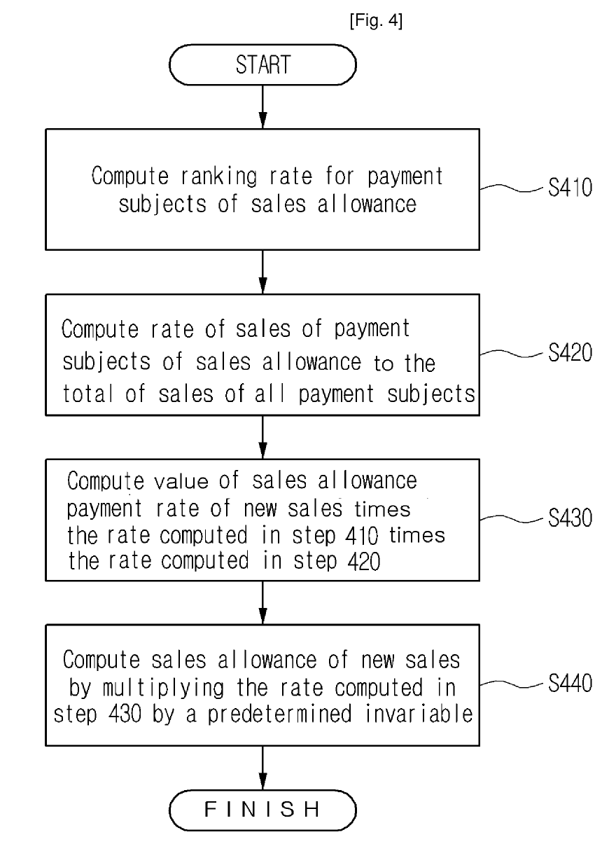

As referred to FIG. 4, payment method of the Equation 1 will be explained exemplifying products or service distribution networks of FIG. 2. Herein, numbers disclosed in the embodiment are impressed by rounding off the numbers to three significant figures.

As depicted in FIG. 2, if sales (50) are generated by a new subscriber R in the case that subscribers corresponding to each node had sales identically in multi-level marketing network having a tree structure, a step of A subscriber is 1, a step of B subscriber is 2, a step of E subscriber is 3, a step of J subscriber is 4, and a step of N subscriber is 5. Herein, because sales are generated by the new subscriber R, a generation step of the new sales is 6 (S410).

In addition, because sales of each subscriber are respectively 50, the total of sales of subscribers paid a sales allowance is 250. And the own sales mean a volume of sales of a new subscriber in case of affiliation of the new subscriber, and thus the own sales of each subscriber is 50 (S420).

Finally, payment rate of new sales mean what percentage is paid to each subscriber as an allowance. If sales of a new subscriber R are 50 and thus payment rate of 50 is 20%, a dividend of 10 is generated (S430). Herein, the invariable, as one for having regard to unit of a sales allowance and payment rate, preferably is 2 (S440).

Accordingly, a sales allowance that each subscriber is paid from a new subscriber R is as follows.

In case of A subscriber, an invariable is 2, a subscriber step is 1, a generation step of new sales is 6, an own sales is 50, the total of sales of subscriber paid sales allowance is 250, and a dividend corresponding to payment rate (20%) of new sales is 10. Thus, if the values are substituted in the Equation 1, a result value is 0.67. Therefore, a sales allowance (0.67) is paid to the A subscriber for the dividend 10.

In case of B subscriber, an invariable is 2, a subscriber step is 2, a generation step of new sales is 6, an own sales is 50, the total of sales of subscriber paid sales allowance is 250, and a dividend corresponding to payment rate (20%) of new sales is 10. Thus, if the values are substituted in the Equation 1, a result value is 1.33. Therefore, a sales allowance (1.33) is paid to the B subscriber for the dividend 10.

In case of E subscriber, an invariable is 2, a subscriber step is 3, a generation step of new sales is 6, an own sales is 50, the total of sales of subscriber paid sales allowance is 250, and a dividend corresponding to payment rate (20%) of new sales is 10. Thus, if the values are substituted in the Equation 1, a result value is 2. Therefore, a sales allowance (2) is paid to the E subscriber for the dividend 10.

Through same method, a sales allowance (2.67) is paid to a J subscriber, and a sales allowance (3.33) is paid to an N subscriber. And the decided sales allowances are provided as numeralized and graphic information on a monitor (not shown). The numeralized information is a number according to monetary unit adjusted randomly, and the graphic information is a graph corresponding to the numeralized information.

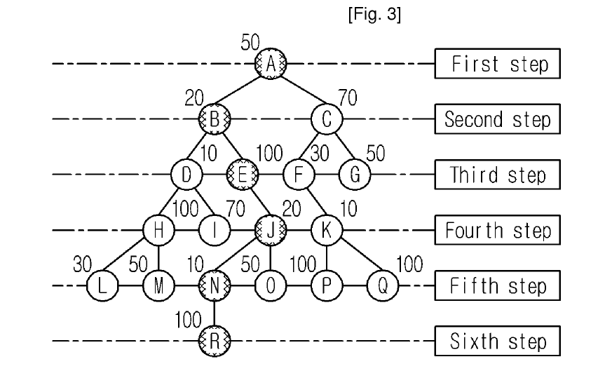

As referred to FIGS. 3 and 4, the cases that subscriber sales are not fixed constantly will be explained hereinafter.

FIG. 3 is a simplified plan for illustrating a sales allowance payment method in accordance with another embodiment of the present invention. Illustrated is one example that an allowance corresponding to a certain rate of sales generated by a subordinated subscriber according to increase of a subordinated subscriber is paid having regard to sales between unsubordinated subscribers having same sales and a ranking rate of corresponding lines.

As depicted in FIG. 3, if sales (100) are generated by a new subscriber R in the case that subscribers corresponding to each node had sales differently in multi-level marketing network having a tree structure, a step of A subscriber is 1, a step of B subscriber is 2, a step of E subscriber is 3, a step of J subscriber is 4, and a step of N subscriber is 5. Herein, because sales are generated by the new subscriber R, a generation step of the new sales is 6 (S410).

In addition, the total of sales of each subscriber paid a sales allowance, as sum (respectively, 50, 20, 100, 20, and 10) of each subscriber sales, is 200. And the own sales mean a volume of sales of a new subscriber in case of affiliation of the new subscriber, and A subscriber is 50, a step of B subscriber is 20, a step of E subscriber is 100, a step of J subscriber is 20, and a step of N subscriber is 10 (S420). Finally, payment rate of new sales mean what percentage is paid to each subscriber as an allowance. If sales of a new subscriber R are 100 and thus payment rate of 100 is 20%, a dividend of 20 is generated (S430). Herein, the invariable, as one for having regard to unit (amount) of a sales allowance and payment rate, preferably is 2 (S440).

Accordingly, a sales allowance that each subscriber is paid from a new subscriber R is as follows.

In case of A subscriber, an invariable is 2, a subscriber step is 1, a generation step of new sales is 6, an own sales is 50, the total of sales of subscriber paid sales allowance is 200, and a dividend corresponding to payment rate (20%) of new sales is 20. Thus, if the values are substituted in the Equation 1, a result value is 1.67. Therefore, a sales allowance (1.67) is paid to the A subscriber for the dividend 20.

In case of B subscriber, an invariable is 2, a subscriber step is 2, a generation step of new sales is 6, an own sales is 20, the total of sales of subscriber paid sales allowance is 200, and a dividend corresponding to payment rate (20%) of new sales is 20. Thus, if the values are substituted in the Equation 1, a result value is 1.33. Therefore, a sales allowance (1.33) is paid to the B subscriber for the dividend 20.

In case of E subscriber, an invariable is 2, a subscriber step is 3, a generation step of new sales is 6, an own sales is 100, the total of sales of subscriber paid sales allowance is 200, and a dividend corresponding to payment rate (20%) of new sales is 20. Thus, if the values are substituted in the Equation 1, a result value is 10. Therefore, a sales allowance (10) is paid to the E subscriber for the dividend 20.

Through same method, a sales allowance (2.67) is paid to a J subscriber, and a sales allowance (1.67) is paid to an N subscriber. The total sum of sales allowances is 17.34, but a corresponding value is converged to a payment rate (20) in the case that the number of subscribers is converged to infinity. A unilateral sales allowance provided to a subscriber would be monopolized. For example, an allowance allotted to an E subscriber corresponds to 10 for the payment rate (20%). Though sales of an A subscriber is 50 as five tenth of an N subscriber, an allotted allowance of the A and N subscribers is equally 1.67. Thus, there is an advantage that weight is applied to individual sales.

On the other hand, as described above, because a payment rate of new sales is applied only when the more a ranking of a subscriber descends downward, the more a step is added in the present invention, there is concern that allowance deviation between higher and lower subscriber become greater. Thus, re-distribution for a profit can be performed by modifying the Equation 1 using another embodiment of the present invention. That is, a payment rate of new sales can be distributed as a predetermined rate. For example, in the case that a payment rate of new sales is designated as 20% and distribution rate of 7:3 is adjusted, the subscriber step (referred to as to “lower adding step” hereinafter) suggested in the Equation 1 is divided into ‘7’ and reverse step (referred to as “higher adding step” hereinafter) of the subscriber step suggested in the Equation 1 is divided into ‘3’

As recognized in the Equation 1, an allowance may not be adequate in a highest subscriber step because the more a subscriber step is higher, the higher is an allowance. Thus, 70% (the ‘7’) of a payment rate is divided from “highest” to “unsubordinated” 30% (the ‘3’) of a payment rate is divided by converting the same reversely, and thus a part of an allowances can be re-distributed.

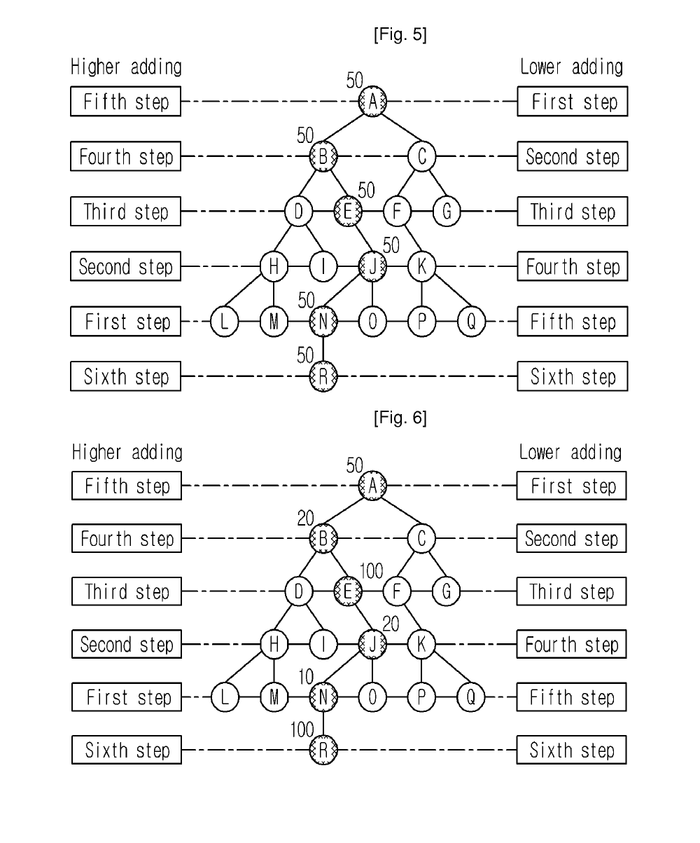

Herein, reverse step of the subscriber step, that is, higher adding step reversely supposes other steps except for a step generating new sales. In other words, in the case that new sales are generated in sixth step of a structure of the first through sixth step depicted in FIGS. 2 and 3, the higher adding step is formed by reversely adjusting the first through fifth step except for the sixth step. Of course, the higher adding step is the same to a result subtracting a subscriber step from generation step of new sales. This structure is depicted in FIGS. 5 and 6.

Accordingly, method for computing the allowance embodied by another embodiment of the present invention is as the following equation 2.

Subscriber allowance=invariable×(subscriber step)/(generation step of new sales)×(own sales)/(the total of sales of subscriber paid sales allowance)×(payment rate of new sales)×first distribution rate+invariable×(generation step of new sales−subscriber step)/(generation step of new sales)×(own sales)/(the total of sales of subscriber paid sales allowance)×(payment rate of new sales)×second distribution rate [Equation 2]

Herein, the first distribution rate and the second distribution rate mean a payment rate corresponding to new sales, and sum of the first distribution rate and the second distribution rate is ‘1’. Thus, in the case that a payment rate is 20% and a rate of the first distribution rate and the second distribution rate is 7:3, the first distribution rate corresponding to new sales 14% and the first distribution rate corresponding to new sales 6%. On the other hand, a ‘dividend rate’ disclosed in FIG. 1 is referred as a ‘payment rate’ and is considered to be an identical conception.

FIGS. 5 and 6 show sales structure according to a subscriber for explaining an embodiment in accordance with the present invention. As depicted the drawings, sales member is formed in steps from A to R. A is located on a first step of the lower adding step and a fifth step of the higher adding step, and B and C are located on a second step of the lower adding step and a fourth step of the higher adding step. And D, E, F and G are located on a third step of the lower adding step and higher adding step, H, I, J and K are located on a fourth step of the lower adding step and a second step of the higher adding step, and L, M, N, O, P and Q are located on a fifth step of the lower adding step and a first step of the higher adding step.

An unstated R is a generation subscriber of new sales, and a corresponding subscriber maintains a final step by getting the lower adding step and the higher adding step identical. That is, in case that the there is a subscriber S in a lower step of a subscriber R and new sales are generated by S, the subscriber R is referred to as a sixth of the lower adding step or a first of the higher adding step. Thus, the pre-stated adding step is computed by subtracting step of a corresponding subscriber that wishes to computing present allowance from the generating step of new sales.

Accordingly, as depicted in FIG. 5, in a profit structure that the lower adding step and the higher adding step are adjusted, in the case that new sales of each subscriber (namely, A, B, E, J and N), including a subscriber R having a generated new sales, are respectively 50 and a payment rate of new sales is 20%, a dividend is 10 (20% of 50) because new sales of a subscriber R is 50. Herein, if a distribution rate is 7:3, a subscriber allowance of the subscriber A is as follows.

First of all, having regarding a generation step of new sales is 6, a lower adding step of a subscriber A is 1 and a higher adding step of the same is 5, an allowance of the subscriber A is;

invariable×(subscriber step−1)/(generation step of new sales−6)×(own sales−50)/(the total of sales of subscriber paid sales allowance−250)×(payment distribution rate of new sales−7 (70% of 10=7))+invariable×(higher adding step−5)/(generation step of new sales−6)×(own sales−50)/(the total of sales of subscriber paid sales allowance−250)×(payment distribution rate of new sales−3 (30% of 10=3))×second distribution rate.

Herein, if the invariable is 2, a subscriber A is allocated an allowance (1.47). In the same manner, an allowance of the subscriber B is as follows.

2×(2/6×50/250)×7+2×(4/6×50/250)×3=1.73

An allowance of a subscriber E, J and N is sequentially as follows.

2×(3/6×50/250)×7+2×(3/6 50/250)×3=2.0

2×(4/6×50/250)×7+2×(2/6 50/250)×3=2.27

2×(5/6×50/250)×7+2×(1/6 50/250)×3=2.53

Herein, underlined figures mean the lower adding step and the higher adding step.

On the other hand, when “payment rate of new sales×first distribution rate” described in the Equation 2 is defined as a first payment distribution rate, the first payment distribution rate is defined as X and the second payment distribution rate is Y, a payment rate of new sales is X+Y.

That is, the payment rate of new sales is sum of the first payment distribution rate of new sales and the second payment distribution rate of new sales. Thus, based on the conception, the above-described Equation 2 is modified as:

Subscriber allowance=invariable×(subscriber step×X)+(generation step of new sales−subscriber step)×Y)/(generation step of new sales)×(own sales)/(the total of sales of subscriber paid sales allowance) [Equation 3]

As described above, if a payment rate of new sales is 20%, a distribution rate is 7:3, and then sales of all subscriber is 50, allowances of a subscriber A, B, E, J and N in the same structure of FIG. 5 through the Equation 3 are respectively computed as follows:

2×(1×7+((6−1)×3))/6×(50/250)=1.47

2×(2×7+((6−2)×3))/6×(50/250)=1.47

2×(3×7+((6−3)×3))/6×(50/250)=2

2×(4×7+((6−4)×3))/6×(50/250)=2.27

2×(5×7+((6−5)×3))/6×(50/250)=2.53

Herein, underlined figures mean the lower adding step and the higher adding step. As described above, the total of allowance of each subscriber is 10 and this result value is identical to a payment rate of new sales. In addition, an allowance deviation according to a subscriber can highly be reduced because new sales are constantly divided as a subscriber and step unit. Of course, the deviation can be increased or decreased according to the above-mentioned distribution rate. A payment distribution rate of new sales (5:5) means that the first payment distribution rate of new sales is identical to the second payment distribution rate of new sales. That is, because the payment rate of new sales is sum of the first payment distribution rate of new sales and the second payment distribution rate of new sales, X is identical to Y as the result of “payment of new sales/2”. Thus, based on the conception, the above-described Equation 3 is modified as:

Subscriber allowance=invariable/2×(own sales)/(the total of sales of subscriber paid sales allowance)×(payment of new sales) [Equation 4]

As described above, if a payment rate of new sales is 20%, a distribution rate is 5:5, and then sales of all subscribers are 50, an allowance of a subscriber A, B, E, J and N in the same structure of FIG. 5 through the Equation 3 is respectively computed as follows:

2×(1×5+((6−1)×5))/6×(50/250)=2

2×(2×5+((6−2)×3))/6×(50/250)=2

2×(3×5+((6−3)×5))/6×(50/250)=2

2×(4×5+((6−4)×5))/6×(50/250)=2

2×(5×5+((6−5)×5))/6×(50/250)=2

As computed above, same allowance is paid to each subscriber. The result value (2) can be computed through the Equation 4.

FIG. 6 is a plan for illustrating another embodiment of distribution structure in accordance with the present invention. A different case is shown according to subscribers or steps. As depicted in FIG. 6, a subscriber A, who is located on a first step of a lower adding step or a fifth step of a higher adding step, generates sales (50), a subscriber B, who is located on a second step of a lower adding step or a fourth step of a higher adding step, generates sales (20), a subscriber E, who is located on a third step of a lower adding step or a third step of a higher adding step, generates sales (100), a subscriber J, who is located on a fourth step of a lower adding step or a second step of a higher adding step, generates sales (20) and a subscriber N, who is located on a fifth step of a lower adding step or a first step of a higher adding step, generates sales (10). In addition, a subscriber R generating new sales (100) is located on a sixth step of a lower adding step or a sixth step of a higher adding step.

Herein, if a payment rate is designated as 20%, a distribution rate is 7:3 and an invariable is 2, an allowance according to each subscriber through the Equation 3 is respectively computed as follows. Here, the total of subscriber sales are 200 (A+B+E+J+N).

2×(1×14+((6−1)×6))/6×(50/200)=3.67

2×(2×14+((6−2)×6))/6×(20/200)=1.73

2×(3×14+((6−3)×6))/6×(100/200)=10

2×(4×14+((6−4)×6))/6×(20/200)=2.27

2×(5×14+((6−5)×6))/6×(10/200)=1.27

Here, the total of allowances of each subscriber is 18.94 and this value is less than 20, but the reason thereof is why sales are respectively differently designated. Thus, in the case that the number of a subscriber is converged to infinity, a corresponding value is exactly converged to a payment rate. And the corresponding value is more approximated than the case applied to only a lower adding step in the same conditions. In addition, an allowance versus retained sales between a higher and lower subscriber was reduced. In the same manner, if a payment rate of new sales (20%) is divided as the rate of 6:4 (lower adding step (12%): higher adding step (8%)), namely, a payment distribution rate of new sales gets fewer, an allowance of a subscriber A is 4.33, an allowance of a subscriber B is 1.87, an allowance of a subscriber E is 10.0, an allowance of a subscriber J is 2.13 and an allowance of a subscriber N is 1.13. Like this, an allowance versus retained sales between a higher and lower subscriber is highly reduced. Herein, the total of allowance paid to each subscriber 19.46, and consequently the value is more approached.

Moreover, if a payment rate of new sales (20%) is divided as the rate of 5:5, a first payment distribution rate of new sales is 10, a second payment distribution rate of new sales is 10 and an invariable is 2, an allowance according to each subscriber through the Equation 3 is respectively computed as follows. Here, the total of subscriber sales is 200 (A+B+E+J+N).

2×(1×10+((6−1)×10))/6×(50/200)=5

2×(2×10+((6−2)×10))/6×(20/200)=2

2×(3×10+((6−3)×10))/6×(100/200)=10

2×(4×10+((6−4)×10))/6×(20/200)=2

2×(5×10+((6−5)×10))/6×(10/200)=1

The result values are computed through the Equation 4 as follows.

2/2×(50/200)×20=5

2/2×(20/200)×20=2

2/2×(100/200)×20=10

2/2×(20/200)×20=2

2/2×(10/200)×20=1

As described above, though new sales are generated in one line, an allowance of a subscriber can be paid and a volume of new sales is constant. And furthermore though a volume of new sales is not constantly fixed, an allowance can be paid. In addition, the problem (e.g. excessive payment of modern multi-level marketing industry, etc) that company goes bankrupt because an allowance paid to a subscriber is more than sales can be solved by concocting a subscriber step and a volume of new sales and correctively paying an allowance versus sales of a subscriber according to a payment rate. Moreover, an allowance deviation between a lower and higher subscriber can be properly adjusted by allotting a payment rate considering a lower adding step and a higher adding step, and thus monopoly of allowance toward a higher subscriber and a lack of sales will are prevented.

The previous description of the disclosed embodiments is provided to enable any person skilled in the art to make or use the present invention. Various modifications to these embodiments will be readily apparent to those skilled in the art, and the generic principles defined herein may be applied to other embodiments without deuniting from the spirit of scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more”. All structural and functional equivalents to the elements of the various embodiments described throughout this disclosure that are known or later come to be known to those of ordinary skill in the art are expressly incorporated herein by reference and are intended to be encompassed by the claims.

### INDUSTRIAL APPLICABILITY

The present invention relates to a sales allowance payment method, more particularly to a calculation method of sales allowance and computer readable recording medium thereof that are capable of calculating allowance to be paid to respective members corresponding to each node online in a commodity or service sales method.

1. A calculation method of sales allowance online comprising the step of:
(A) computing the sales allowance based on sales of respective subscribers and a relative ranking of the subscribers in case of paying the sales allowance to subscribers included on one line.

2. The method according to claim 1, wherein the method further comprises:
(A1) computing a rate of a ranking of a predetermined subscriber to the number of subscribers included on one line;
(A2) computing a rate of sales of the predetermined subscriber to the total of sales of respective subscribers included on the one line;
(A3) computing the rate computed in the step (A1) times the rate computed in the step (A2) times a sales allowance payment rate of new sales;
(A4) automatically computing an allowance of the predetermined subscriber by the product of the value computed in the step (A3) and a predetermined invariable; and
(A5) displaying the value computed in the step (A4) on the monitor of a computer.

3. The method according to claim 2, wherein the method further comprises:
(A6) dividing the sales allowance payment rate of the new sales at a predetermined rate, and thus computing a first payment distribution rate X and a second payment distribution rate Y of the new sales;
(A7) outputting a value of the value computed in the step (A4) times the first payment distribution rate X of the new sales;
(A8) re-computing the rate computed in the step (A1) as an allowance corresponding to ‘1’ and then computing each subscriber allowance through the step (A1) to the step (A4);
(A9) outputting a value of the value computed in the step (A8) times the second payment distribution rate X of the new sales; and
(A10) summing the value computed in the step (A7) and the value computed in the step (A9), and then returning the summation value to the step (A5) through the feedback procedure.

4. The method according to claim 3, wherein the predetermined rate is a percentage of 50:50.

5. A computer readable recording medium for calculating a sales allowance online, comprising:
a first computing means for computing a rate of a ranking of a predetermined subscriber to the number of subscribers included on one line;
a second computing means for computing a rate of sales of the predetermined subscriber to the total of sales of respective subscribers included on the one line;
a third computing means for computing the rate computed by the first computing means times the rate computed by the second computing means times a sales allowance payment rate of new sales; and
a fourth computing means for automatically computing an allowance of the predetermined subscriber by the product of the value computed by the third computing means and a predetermined invariable.
